(19) United States
(12) Patent Application Publication
(10) Pub. No.: US 2019/0220872 A1
(43) Pub. Date: Jul. 18, 2019

(54) INFORMATION PROCESSING APPARATUS, INFORMATION PROCESSING SYSTEM, AND NON-TRANSITORY COMPUTER READABLE MEDIUM STORING PROGRAM

(71) Applicant: FUJI XEROX CO., LTD., Tokyo (JP)

(72) Inventor: Takeshi YAMASHITA, Kanagawa (JP)

(73) Assignee: FUJI XEROX CO., LTD., Tokyo (JP)

(21) Appl. No.: 16/208,570

(22) Filed: Dec. 4, 2018

(30) Foreign Application Priority Data
Jan. 17, 2018 (JP) 2018-005565

(51) Int. Cl. G06Q 30/02; G06Q 30/06; G06Q 10/06

(52) U.S. Cl. CPC G06Q 30/0201; G06Q 30/0281; G06Q 10/06398; G06Q 30/0627

(57) ABSTRACT

An information processing apparatus includes a setting section that sets a range of a user capable of using a search condition for searching for a customer to any stage among plural stages, and a search section that performs a search using the search condition in response to the search request of the user corresponding to a range in which the search condition is capable of being used in the stage set by the setting section.

### CROSS-REFERENCE TO RELATED APPLICATIONS

This application is based on and claims priority under 35 USC 119 from Japanese Patent Application No. 2018-005565 filed Jan. 17, 2018.

### BACKGROUND

### (i) Technical Field

The present invention relates to an information processing apparatus, an information processing system, and a non-transitory computer readable medium storing a program.

### (ii) Related Art

JP2001-209701A discloses that a potential customer search condition is registered for each agency in an agency supporting apparatus and a potential customer is searched by using the registered potential customer search condition.

### SUMMARY

There may be a case where a salesperson who performs a sales activity relating to a sale of the product searches for a customer using, for example, an information processing apparatus. In such information processing apparatus, for example, the customer is searched for using a search condition for searching for the customer.

Here, for example, in a case where the accuracy of the search condition is low, a customer inappropriate as a sales destination of the product maybe searched for. In such case, in a case where the sales activity is performed for each customer searched for using the search condition without limiting a user capable of using the search condition, there is a risk that the scale of the disadvantage such as a reduction of the efficiency in the sales activity increases.

Aspects of non-limiting embodiments of the present disclosure relate to a technic capable of setting a specific user as a user capable of using a search condition.

Aspects of certain non-limiting embodiments of the present disclosure overcome the above disadvantages and other disadvantages not described above. However, aspects of the non-limiting embodiments are not required to overcome the disadvantages described above, and aspects of the non-limiting embodiments of the present disclosure may not overcome any of the problems described above.

According to an aspect of the present disclosure, there is provided an information processing apparatus including a setting section that sets a range of a user capable of using a search condition for searching for a customer to any stage among a plurality of stages, and a search section that performs a search using the search condition in response to a search request of the user corresponding to the range in which the search condition is capable of being used, in the stage set by the setting section.

### BRIEF DESCRIPTION OF THE DRAWINGS

Exemplary embodiment(s) of the present invention will be described in detail based on the following figures, wherein:

FIG. 1 is a diagram showing an entire configuration of an information processing system according to an exemplary embodiment;

FIG. 2 is a diagram showing a functional configuration of a management server;

FIG. 3 is a diagram showing a functional configuration of a client terminal;

FIG. 4 is a diagram showing a hardware configuration example of a computer used as the management server and the client terminal;

FIG. 5 is a diagram showing a configuration example of a product information management table;

FIG. 6 is a diagram showing a configuration example of a search condition management table;

FIG. 7 is a diagram showing a configuration example of a setting pattern table;

FIG. 8 is a diagram showing a configuration example of the setting pattern table;

FIG. 9 is a diagram showing a configuration example of a sales activity management table;

FIG. 10 is a diagram showing a configuration example of a salesperson management table;

FIG. 11 is a diagram showing a configuration example of a customer management table;

FIG. 12 is a flowchart showing a flow of use determination processing by the information processing system;

FIG. 13A is a diagram showing a product displayed on a display section in a case where a salesperson “A” logs in to the client terminal, and 13B is a diagram showing a product displayed on the display section in a case where a salesperson “B” logs in to the client terminal;

FIG. 14 is a diagram showing a search result in a case where a search of a customer is performed;

FIG. 15 is a diagram showing the sales activity management table to which a situation of a new sales activity is added;

FIG. 16 is a flowchart showing a flow of shifting processing by the information processing system; and

FIG. 17 is a flowchart showing a flow of the shifting processing by the information processing system.

### DETAILED DESCRIPTION

Hereinafter, an exemplary embodiment of the present invention will be described in detail with reference to the accompanying drawings.

Configuration of Information Processing System

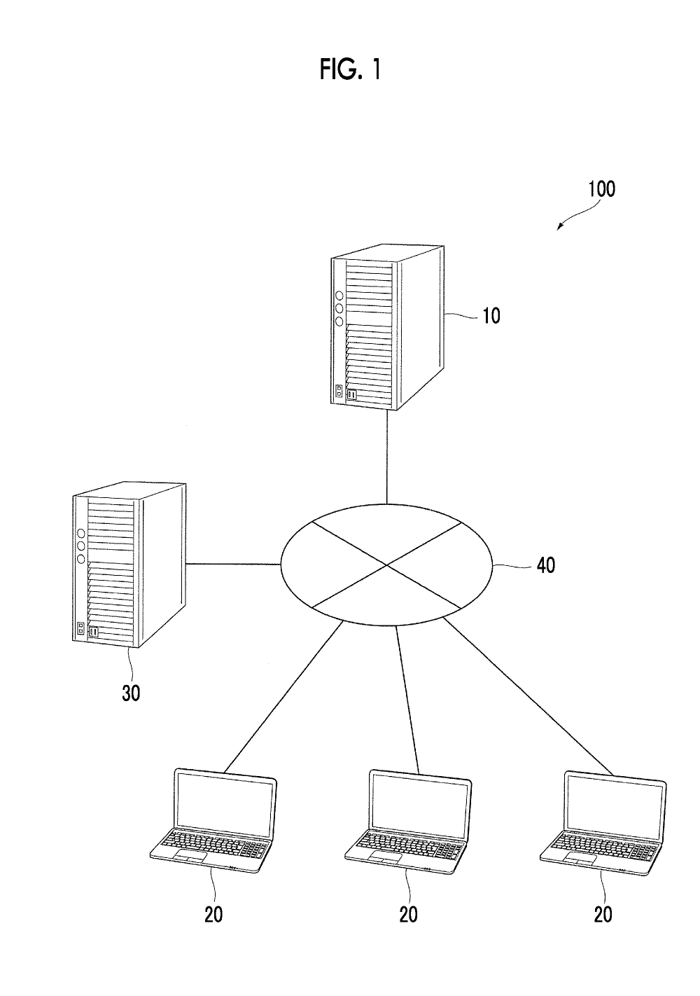

FIG. 1 is a diagram showing an entire configuration of an information processing system according to the exemplary embodiment. An information processing system 100 of the exemplary embodiment includes a management server 10, a client terminal 20 used for accessing the management server 10 by a user, and a customer server 30 used for accessing the management server 10 by a customer. The management server 10 and the client terminal 20, and the management server 10 and the customer server 30 are respectively connected to each other through a network 40.

The management server 10 is a server that manages customer information relating to the customer that the user has, product information relating to a product that the user intends to sell, and the like. The management server 10 manages also salesperson information relating to the user (hereinafter, referred to as salesperson) who performs a sales activity relating to a sale of the product to the customer. The management server 10 searches for the customer as a sales destination of the product using the product information and the customer information. More specifically, the management server 10 searches for a customer corresponding to a search condition for searching for the customer as the sales destination of the product using the product information and the customer information. The search condition is a condition used for narrowing the customers by the management server 10. As the search condition, for example, an attribute of a facility owned by the customer such as a type, a function, or the like of an information processing apparatus used by the customer is used. The facility includes hardware equipment and software equipment. The management server 10 searches for the customer in response to a request from the client terminal 20 and transmits the customer information to the client terminal 20.

The management server 10 is realized by, for example, a computer. The management server 10 may be configured by a single computer or may be realized by distributed processing by a plurality of computers.

The client terminal 20 is an information processing apparatus that connects to the management server 10 through the network 40 and performs a search request for the customer to the management server 10 to acquire the customer information on a customer searched by the management server 10. The client terminal 20 has a display unit that displays the searched customer.

The client terminal 20 is realized by, for example, the computer, a tablet type information terminal, another information processing apparatus.

The management server 10 and the client terminal 20 are examples of the information processing apparatus.

The customer server 30 is a server that collects and manages information relating to the attribute of the facility owned by the customer and information generated by the customer using the information processing apparatus. The customer server 30 has a function of connecting to the management server 10 through the network 40 and transmitting the information managed by the customer server 30 to the management server 10. The information transmitted from the customer server 30 is associated with information for identifying the customer and is managed by the management server 10.

The customer server 30 is realized by, for example, the computer.

In the exemplary embodiment, the information relating to the attribute of the facility owned by the customer and the information generated by the customer using the information processing apparatus are transmitted from the information processing apparatus to the customer server 30 by software installed in the information processing apparatus used by the customer.

The network 40 is an information communication network that is responsible for communication between the management server 10 and the client terminal 20 and between the management server 10 and the customer server 30. The type of the network 40 is not particularly limited as long as transmitting and receiving of data are possible and may be, for example, the Internet, a local area network (LAN), or a wide area network (WAN). A communication channel used for data communication maybe wired or wireless. A configuration that each apparatus is connected to each other through a plurality of networks or communication channels may be employed.

In the exemplary embodiment, in order to allow only a specific salesperson to use the search of the customer using the search condition, the management server 10 performs processing (hereinafter, referred to as use determination processing) of determining whether a salesperson can use the search of the customer using the search condition.

Furthermore, in the exemplary embodiment, a range of the salesperson capable of using the search condition (hereinafter, referred to as use range) is set to any stage among a plurality of stages, and the management server 10 performs processing (hereinafter, referred to as shifting processing) of shifting the set stage (hereinafter, referred to as setting stage) to another stage. The contents of the use determination processing and the shifting processing will be described in detail below. In the exemplary embodiment, the salesperson is an example of a user who uses the search condition.

Functional Configuration of Management Server

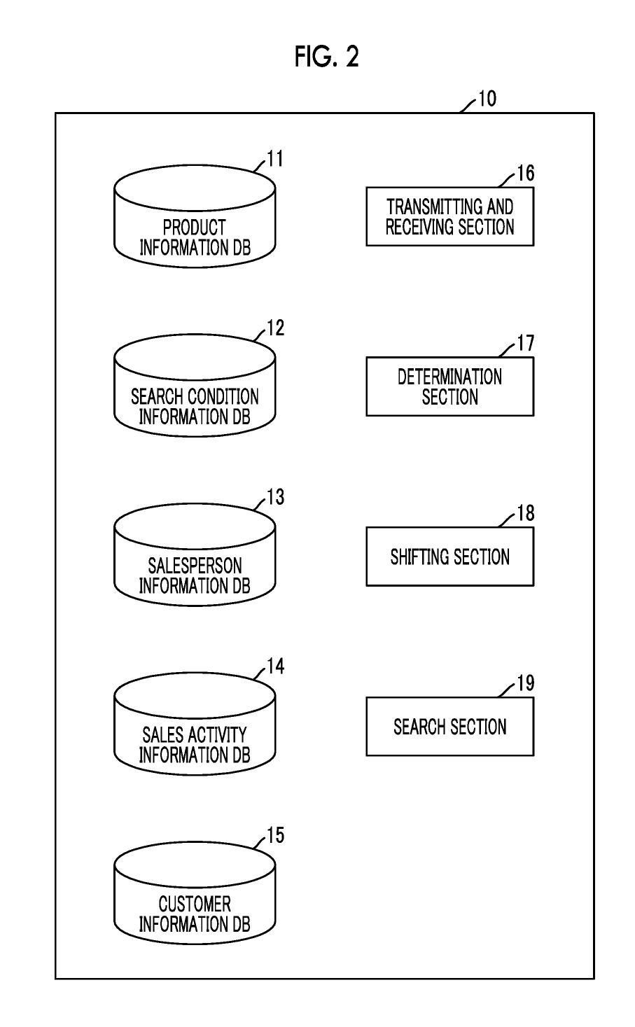

Next, a functional configuration of the management server 10 will be described. FIG. 2 is a diagram showing the functional configuration of the management server 10.

As shown in FIG. 2, the management server 10 includes a product information database (DB) 11, a search condition information database (DB) 12, a salesperson information database (DB) 13, a sales activity information database (DB) 14, and a customer information database (DB) 15. The management server 10 also includes a transmitting and receiving section 16, a determination section 17, a shifting section 18, and a search section 19.

The product information DB 11 is a database that holds the product information on the product that the salesperson intends to sell to the customer.

The product includes not only goods but also software or service. Examples of the product information include a product name, the number of products sold to the customer, and a contract success rate in a case where the sales activity is performed for the customer. The contract success rate is a ratio between the number of cases where the sale of the product is successful and the number of cases where the sale of the product is unsuccessful in the case where the sales activity is performed for the customer.

The search condition information DB 12 is a database that holds search condition information. Examples of the search condition information include the contents of the search condition, a product associated with the search condition, a setting pattern applied to the search condition, the setting stage of the search condition, the number of uses of the search condition, and a setting date and a shifting date of the setting stage of the search condition. The setting pattern is a type used as a rule in a case where the use range of the search condition is set. In the exemplary embodiment, the use range of the search condition is set in stages according to the setting pattern. A plurality of types of setting patterns are provided, and any of the setting patterns is applied for each search condition. The specific contents of the setting pattern will be described below.

The salesperson information DB 13 is a database that holds the salesperson information. Examples of the salesperson information include a salesperson name, an affiliation of the salesperson, and the number of successful contracts and the number of sales of the product by the salesperson.

The sales activity information DB 14 is a database that holds a history of the sales activity performed by the salesperson. Examples of the history of the sales activity include presence or absence of a successful contract, a time required from the start to the end of the sales activity, and the number of sales of the product in a case where the contract is successful for each sales activity.

The customer information DB 15 is a database that holds the customer information. Examples of the customer information include a customer name, a location of the customer, and the attribute of the facility owned by the customer.

The transmitting and receiving section 16 is communication means that exchanges data with an external apparatus. The transmitting and receiving section 16 receives identification information for identifying a salesperson who uses the client terminal 20 from the client terminal 20. The transmitting and receiving section 16 transmits the product information and the customer information of a searched customer to the client terminal 20. The transmitting and receiving section 16 also receives information transmitted from the customer server 30.

The determination section 17 is determination means that determines whether to allow the salesperson to use the search condition. Specifically, the determination section 17 determines whether to allow the salesperson who uses the client terminal 20 to use the search of the customer using the search condition. In other words, the determination section 17 determines whether a salesperson specified from the identification information corresponds to a salesperson set in the use range at the setting stage of the search condition with reference to the search condition information held in the search condition information DB 12 and the identification information of the salesperson received by the transmitting and receiving section 16. In a case where the specified salesperson corresponds to the defined salesperson, the salesperson can use the search condition.

The shifting section 18 is shifting means (setting unit) that shifts the setting stage of the search condition. In a case where a shifting condition set by the setting pattern applied to the search condition is satisfied, the shifting section 18 shifts the setting stage of the search condition. The shifting section 18 is an example of a setting section that sets the setting stage of the search condition. The shift in the stage of the search condition is an example of the setting of the stage of the search condition.

The search section 19 is a search unit that searches for the customer using the search condition. In a case where the search request for the customer for a specific product is received from the client terminal 20, the search section 19 refers to the product information held in the product information DB 11, the search condition information held in the search condition information DB 12, and the customer information held in the customer information DB 15. The search section 19 searches for a customer corresponding to the search condition associated with the product related to the search request.

Functional Configuration of Client Terminal

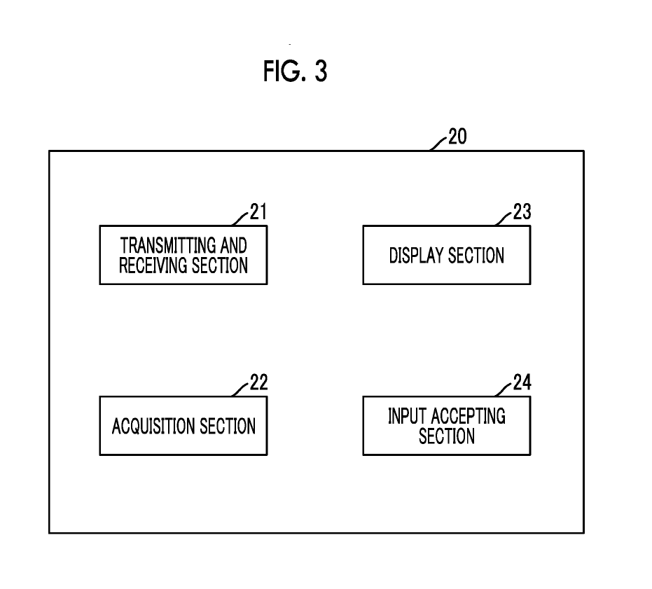

FIG. 3 is a diagram showing a functional configuration of the client terminal 20 of the exemplary embodiment. The client terminal 20 includes a transmitting and receiving section 21, an acquisition section 22, a display section 23, an input accepting section 24.

The transmitting and receiving section 21 is the communication means that exchanges data with an external apparatus. The transmitting and receiving section 21 transmits the identification information of the salesperson and the product information of the product related to the search request to the management server 10. The transmitting and receiving section 21 also receives the product information of the product and the customer information of the searched customer from the management server 10.

The acquisition section 22 is an acquisition unit that acquires the identification information of the salesperson. The salesperson inputs the identification information into the client terminal 20 to log in, and the acquisition section 22 acquires the identification information and performs authentication of the salesperson based on the acquired identification information.

As an input method of the identification information, for example, a method that the identification information is read by putting an identification (ID) card in which different identification information is recorded for each salesperson over an ID card reader (not shown) or a method that the salesperson itself inputs an identification number or a password registered for each salesperson to a display screen can be applied. The acquisition section 22 is an example of an authentication unit that performs the authentication of the user.

The display section 23 is the display unit that displays the product as a search key. The display section 23 displays the searched customer as a result of the search by the search section 19 of the management server 10.

The input accepting section 24 is an accepting unit that accepts an operation performed by the salesperson. The input accepting section 24 accepts the operation for the search request for the customer.

Hardware Configuration of Computer

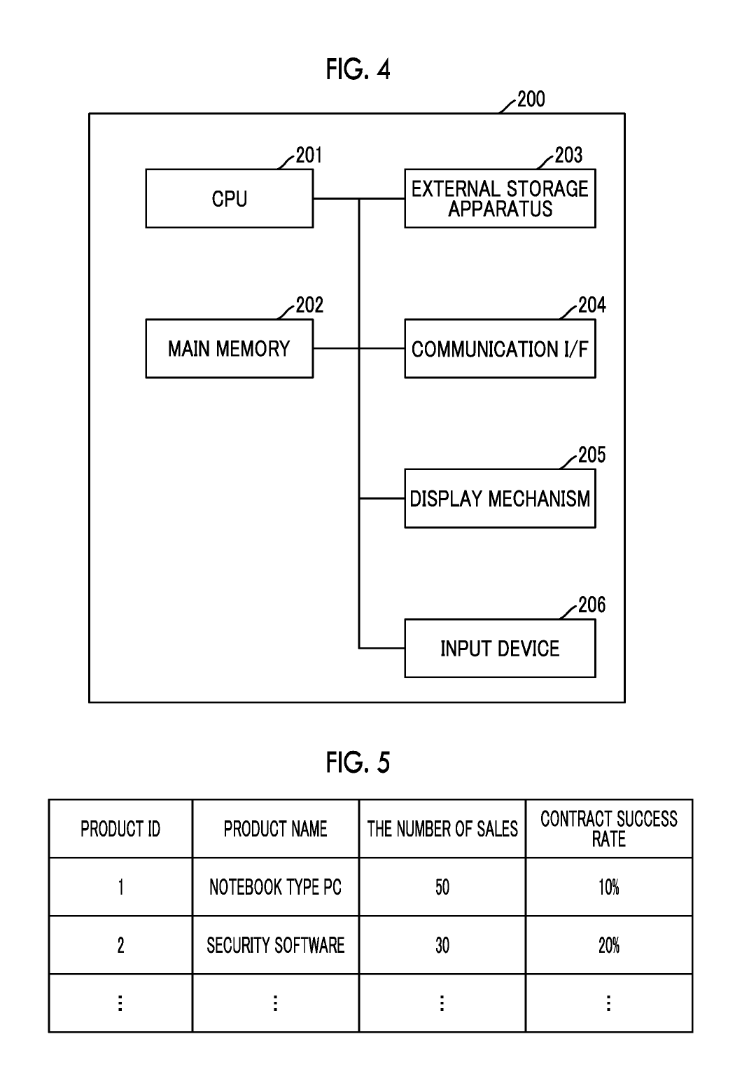

FIG. 4 is a diagram showing a hardware configuration example of the computer used as the management server 10 and the client terminal 20. A computer 200 shown in FIG. 4 includes a central processing unit (CPU) 201 that is calculation means, and a main storage apparatus (main memory) 202 and an external storage apparatus 203 that are storage means. The CPU 201 reads a program stored in the external storage apparatus 203 into the main storage apparatus 202 and executes the program. For example, a random access memory (RAM) is used as the main storage apparatus 202. For example, a magnetic disk apparatus or a solid state drive (SSD) is used as the external storage apparatus 203. The computer 200 includes a communication interface 204 for connecting to a network and a display mechanism 205 for performing a display output to a display. The computer 200 includes an input device 206 by which an input operation by an operator of the computer 200 is performed. The configuration of the computer 200 shown in FIG. 4 is only an example, and the computer used in the exemplary embodiment is not limited to the configuration example of FIG. 4. For example, a configuration including a non-volatile memory such as a flash memory or a read only memory (ROM) as the storage apparatus may be employed.

In a case where the management server 10 shown in FIG. 2 is realized by the computer 200 shown in FIG. 4, the product information DB 11, the search condition information DB 12, the salesperson information DB 13, the sales activity information DB 14, and the customer information DB 15 are realized by, for example, the main storage apparatus 202 or the external storage apparatus 203. The function of the transmitting and receiving section 16 is realized by, for example, the communication interface 204. Each function of the determination section 17, the shifting section 18, and the search section 19 is realized by, for example, the CPU 201 executing the program.

In a case where the client terminal 20 shown in FIG. 3 is realized by the computer 200 shown in FIG. 4, the transmitting and receiving section 21 is realized by, for example, the communication interface 204. The acquisition section 22 is realized by, for example, the CPU 201 executing the program. The display section 23 is realized by, for example, the display mechanism 205. The input accepting section 24 is realized by, for example, the input device 206 and the CPU 201.

The program for realizing the exemplary embodiment of the present invention can be provided not only by the communication means but also by storing in a recording medium such as a CD-ROM.

Table Held in Management Server

Next, the contents of various data tables held in the management server 10 will be described.

FIG. 5 is a diagram showing a configuration example of a product information management table. The product information management table is held in the product information DB 11.

In the product information management table shown in FIG. 5, “product ID” indicates the identification number for identifying the product, and “product name” indicates a name of the product. In the product information management table, “the number of sales” indicates the number of sales of the product to the customer. “Contract success rate” indicates the contract success rate of the product.

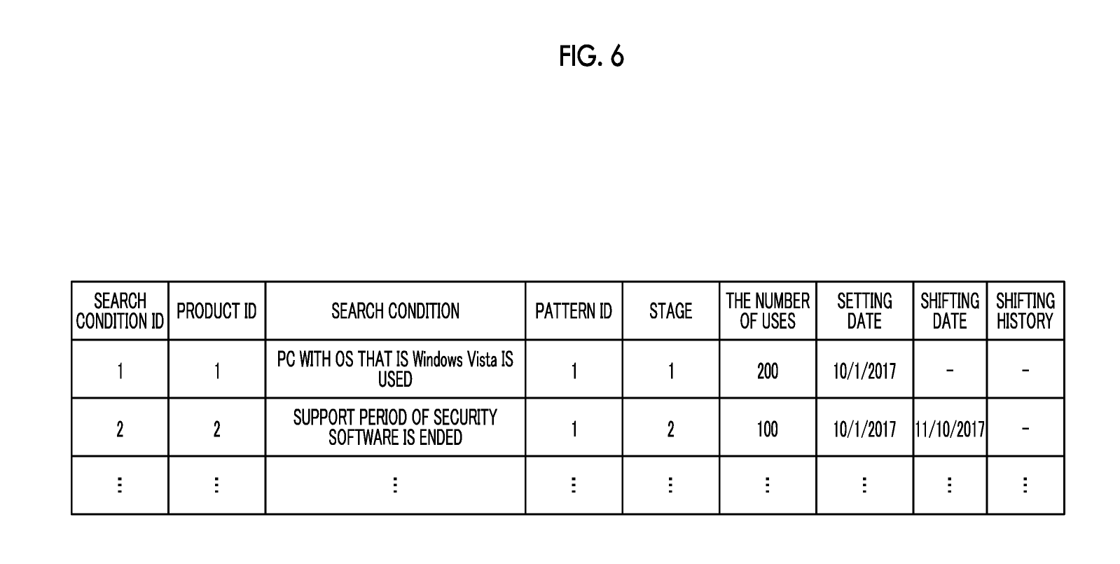

FIG. 6 is a diagram showing a configuration example of a search condition management table. The search condition management table is held in the search condition information DB 12.

In the search condition management table shown in FIG. 6, “search condition ID” indicates the identification number for identifying the search condition, and “product ID” indicates the product ID of the product associated with the search condition. In the search condition management table, “search condition” indicates the contents of the search condition, and “pattern ID” indicates the identification number for identifying the setting pattern applied to the search condition. “Stage” indicates the setting stage of the search condition, and “the number of uses” indicates the number of times the customer is searched for using the search condition. “Setting date” indicates a date on which any of the stages is set for the first time as the use range of the search condition, and “shifting date” indicates a date on which the setting stage of the search condition is last shifted. In “shifting history”, in a case where the setting stage of the search condition is shifted the number of times set in advance (for example, three times) from a stage where a larger number of salespersons are set to a stage where a smaller number of salespersons are set, the fact is indicated.

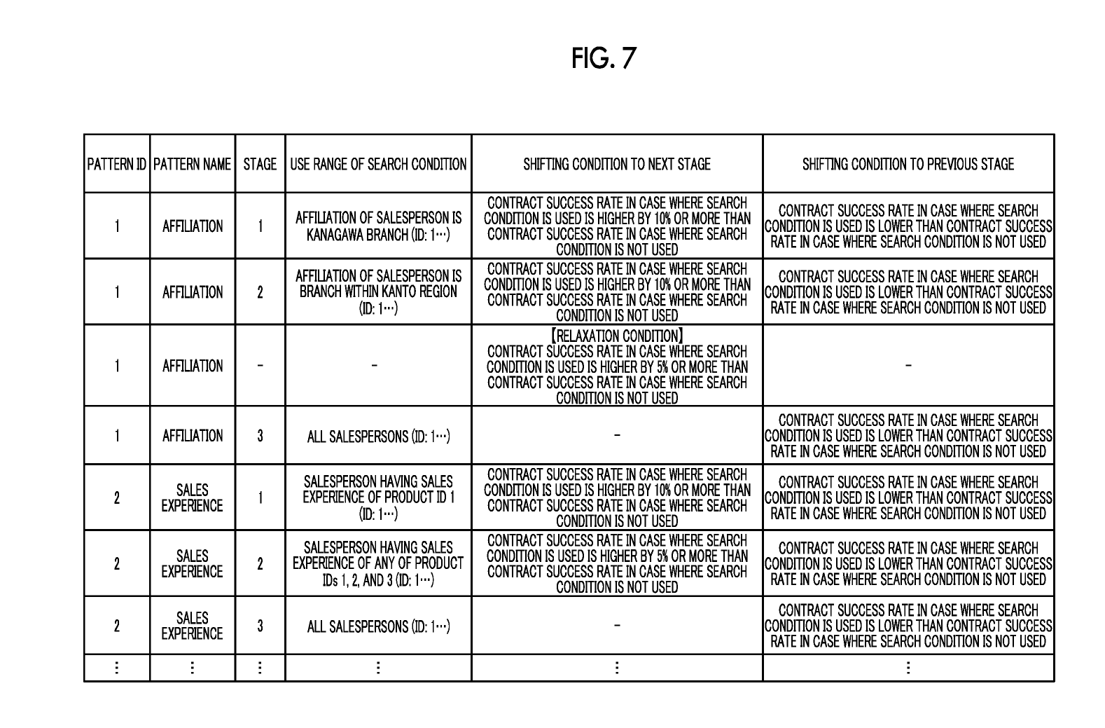

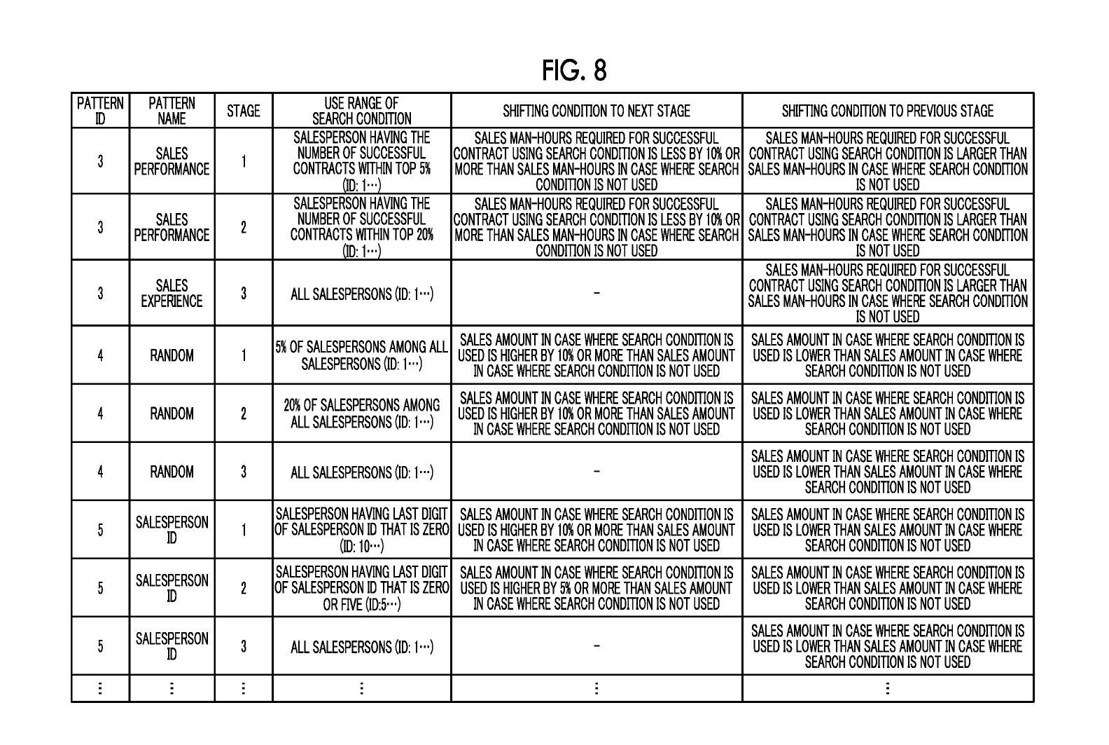

FIGS. 7 and 8 are diagrams showing configuration examples of a setting pattern table. The setting pattern table is held in the search condition information DB 12.

In the setting pattern tables shown in FIGS. 7 and 8, “pattern ID” indicates the identification number of the setting pattern (refer to FIG. 6), and “pattern name” indicates a name of the setting pattern. In the setting pattern table, “stage” indicates the stage applied in setting the use range of the search condition. In a state where the stage indicated in “stage” is applied in the setting pattern indicated in “pattern name”, “use range of search condition” indicates the range of the salesperson capable of using the search condition and the identification number of the salesperson capable of using the search condition. “Shifting condition to next stage” indicates a condition for shifting the setting stage of the search condition to one next stage (shifting from stage “1” to stage “2” or from stage “2” to stage “3”). Furthermore, “Shifting condition to previous stage” indicates a condition for shifting the setting stage of the search condition to one previous stage (shifting from stage “3” to stage “2” or from stage “2” to stage “1”). The contents of the shifting condition will be described below.

The setting pattern will be described. In the exemplary embodiment, five types of “affiliation”, “sales experience”, “sales performance”, “random”, and “salesperson ID” are provided as the setting pattern, and any of the setting patterns is applied for each search condition.

As shown in FIG. 7, in the setting pattern of “affiliation”, the use range of the search condition is correlated with the range of the salesperson separated based on the affiliation of the salesperson. Specifically, in the setting pattern of “affiliation”, the use range of stage “1” is correlated with a salesperson belonging to a Kanagawa branch. The use range of stage “2” is correlated with salespersons belonging to branches within the Kanto region (including Tokyo, Saitama, Kanagawa, Chiba, Yamanashi, Ibaraki, Gunma, and Tochigi).

It is possible to select the setting pattern of “affiliation” from the viewpoint focused on the salesperson or from the viewpoint focused on the customer. A case where the setting pattern of “affiliation” is selected from the viewpoint focused on the salesperson is, for example, a case where the setting pattern of “affiliation” is selected focusing on an easily manageable salesperson such as the salesperson of an affiliation where the sales activity is immediately suspended in a case where an outcome of the sales activity does not improve. A case where the setting pattern of “affiliation” is selected from the viewpoint focused on the customer is, for example, a case where the setting pattern of “affiliation” is selected focusing on a customer desired to be a target of the sales activity such as in a case where the sales activity is desired to be performed for the customer in a specific area.

In the setting pattern of “sales experience”, the use range of the search condition is correlated with the range of the salesperson separated based on the sales experience of the product in the sales activity of the salesperson. Specifically, in the setting pattern of “sales experience”, the use range of stage “1” is correlated with a salesperson having the sales experience of a product (for example, with product ID of “1”) associated with the search condition. The use range of stage “2” is correlated with a salesperson having the sales experience of products (for example, products with product IDs of “1”, “2”, and “3”) identical or similar to the product associated with the search condition.

The setting pattern of “sales experience” is applied in a case where the search condition is desired to be used only for the salesperson having the sales experience of the product associated with the search condition. The case where the search condition is desired to be used only for the salesperson having the sales experience of the product associated with the search condition is, for example, a case where the sales activity is easily performed in a case where the salesperson has the sales experience of the product as compared with a case where the salesperson does not have the sales experience of the product.

As shown in FIG. 8, in the setting pattern of “sales performance”, the use range of the search condition is correlated with the range of the salesperson separated based on the sales performance of the product in the sales activity. Specifically, in the setting pattern of “sales performance”, the use range of stage “1” is correlated with a salesperson having the number of successful contracts within top 5% among all salespersons. The use range of stage “2” is correlated with a salesperson having the number of successful contracts within top 20% among all salespersons.

Examples of the sales performance include the number of successful contracts and the number of sales of the product in the sales activity of the salesperson. The number of successful contracts and the number of sales may be the number of successful contracts and the number of sales in the specific product such as the product identical or similar to the product relating to the search condition associated with “sales performance” instead of in all products.

The setting pattern of “sales performance” is applied in a case where the search condition is desired to be used only for a salesperson having excellent sales performance of the product. The case where the search condition is desired to be used only for a salesperson having excellent sales performance of the product is, for example, a case where the salesperson having the excellent sales performance easily performs the sales activity as compared with a salesperson having poor sales performance.

In the setting patterns of “sales experience” and “sales performance”, the use ranges of the search conditions are set in stages based on the history of the sales activity. More specifically, in the setting patterns of “sales experience” and “sales performance”, the use ranges of the search conditions are set in stages based on achievement of the sales activity.

In the setting pattern of “random”, the use range of the search condition is correlated with a salesperson extracted in advance by a supervisor supervising the salesperson regardless of the affiliation, the sales experience, the sales performance, and the like. Specifically, in the setting pattern of “random”, the use range of stage “1” is correlated with 5% of salespersons among all salespersons. The use range of stage “2” is correlated with 20% of salespersons among all salespersons. In the exemplary embodiment, in the setting pattern of “random”, the salespersons corresponding to the use range of stage “1” are assumed to correspond to the use range of stage “2”.

In the setting pattern of “salesperson ID”, the use range of the search condition is correlated with the range of the salesperson separated based on the identification number of the salesperson. Specifically, in the setting pattern of “salesperson ID”, the use range of stage “1” is correlated with a salesperson having the last digit of the salesperson ID that is “0”. The use range of stage “2” is correlated with a salesperson having the last digit of the salesperson ID that is “0” or “5”.

The setting patterns of “random” and “salesperson ID” are used in a case where it is not desired to bias these attributes of the salesperson for the salesperson who correlates with the use range of the search condition. The attribute of the salesperson is an attribute determined from the viewpoint focused on the sales activity performed by the salesperson. Examples of the attribute of the salesperson include the affiliation of the salesperson, the sales experience, and the sales performance.

In a case where the accuracy of the search condition is high, since a customer appropriate for the sale of the product is searched for, it becomes easier to make a contract successful in a case where the sales activity is performed for the searched customer. Therefore, in a case where a contract success rate in the sales activity for the customer searched for using the search condition is higher than a contract success rate in the sales activity for the customer other than the customer searched for using the search condition, one of factors in the high contract success rate is the high accuracy of the search condition.

On the other hand, for example, there may be a case where a salesperson having a specific attribute such as the excellent sales performance performs the sales activity using the search condition and makes the contract successful. In the case, as a factor in making the contract successful, it is difficult to distinguish whether the salesperson has the specific attribute or the accuracy of the search condition is high.

Thus, in a case where it is desired to determine whether the accuracy of the search condition is high based on a result of the sales activity by the salesperson regardless of whether the salesperson has the specific attribute, the setting patterns of “random” or “salesperson ID” is applied.

In this manner, in the exemplary embodiment, a plurality of setting patterns are provided, and any of the setting patterns is applied according to the contents of the search condition. The applied setting pattern is determined according to the product or the contents of the search condition.

In the exemplary embodiment, the setting pattern and the applied stage are set to determine the use range of the search condition.

In the setting stage “2” rather than “1”, and “3” rather than “2” (in the next stage), the use range of the search condition is expanded, that is, the number of salespersons capable of using the search condition increases. In other words, in the setting stage “2” rather than “3”, and “1” rather than “2” (in the previous stage), the use range of the search condition is reduced, that is, the number of salespersons capable of using the search condition decreases. In any setting pattern, the use range of stage “3” is correlated with all salespersons. Here, not all salespersons but some salespersons may be correlated with the use range of stage “3”. The number of applied stages may be larger than three. In a case where the shifting condition to the previous stage is satisfied when the setting stage is “1”, for example, the use range of the search condition may be not correlated with the salesperson, that is, any salesperson may be prevented from using the search condition.

Next, the shifting condition of the setting stage will be described.

A condition relating to the result of the sales activity performed for the customer searched for using the search condition is set in the shifting condition of the setting stage.

As shown in FIG. 7, in stages “1” and “2” of the setting pattern of “affiliation” and stage “1” of the setting pattern of “sales experience”, the shifting condition to the next stage is that the contract success rate in the case where the search condition is used is higher than the contract success rate in the case where the search condition is not used. Specifically, the shifting condition to the next stage is that the contract success rate in the case where the sales activity is performed for the customer searched for using the search condition is higher by 10% (first ratio) or more than the contract success rate in the case where the sales activity is performed for the customer other than the customer searched for using the search condition. In stage “2” of the setting pattern of “sales experience”, the shifting condition to the next stage is that the contract success rate in the case where the sales activity is performed for the customer searched for using the search condition is higher by 5% or more than the contract success rate in the case where the sales activity is performed for the customer other than the customer searched for using the search condition.

In a case where the specific condition is satisfied, a relaxation condition in which the condition as the shifting condition to the next stage is relaxed is applied. The relaxation condition in the setting pattern of “affiliation” is that the contract success rate in the case where the sales activity is performed for the customer searched for using the search condition is higher by 5% (second ratio smaller than first ratio) or more than the contract success rate in the case where the sales activity is performed for the customer other than the customer searched for using the search condition. In the exemplary embodiment, the relaxation condition is provided for any setting pattern (not shown).

In stages “1” and “2” of the setting pattern of “affiliation” and stages “1” and “2” of the setting pattern of “sales experience”, the shifting condition to the previous stage is that the contract success rate in the case where the search condition is used is lower than the contract success rate in the case where the search condition is not used. Specifically, the shifting condition to the previous stage is that the contract success rate in the case where the sales activity is performed for the customer searched for using the search condition is lower than the contract success rate in the case where the sales activity is performed for the customer other than the customer searched for using the search condition.

As shown in FIG. 8, in stage “1” of the setting pattern of “sales performance”, the shifting condition to the next stage is that sales man-hours required for the successful contract in the case where the search condition is used is less than sales man-hours required for the successful contract in the case where the search condition is not used. Specifically, the shifting condition to the next stage is that an average sales man-hours required for the successful contract in the case where the sales activity is performed for the customer searched for using the search condition is less by 10% or more than an average sales man-hours required for the successful contract in the case where the sales activity is performed for the customer other than the customer searched for using the search condition. In stage “2” of the setting pattern of “sales performance”, the shifting condition to the next stage is that an average sales man-hours required for the successful contract in the case where the sales activity is performed for the customer searched for using the search condition is less by 10% or more than an average sales man-hours required for the successful contract in the case where the sales activity is performed for the customer other than the customer searched for using the search condition. Here, the sales man-hours is a time spent on sales activity by the salesperson.

In stages “1” and “2” of the setting pattern of “sales performance”, the shifting condition to the previous stage is that the sales man-hours required for the successful contract in the case where the search condition is used is larger than the sales man-hours required for the successful contract in the case where the search condition is not used. Specifically, the shifting condition to the previous stage is that the average sales man-hours required for the successful contract in the case where the sales activity is performed for the customer searched for using the search condition is larger than the average sales man-hours required for the successful contract in the case where the sales activity is performed for the customer other than the customer searched for using the search condition.

In stages “1” and “2” of the setting pattern of “random” and stage “1” of the setting pattern of “salesperson ID”, the shifting condition to the next stage is that a sales amount in the case where the search condition is used is higher than a sales amount in the case where the search condition is not used. Specifically, the shifting condition to the next stage is that an average sales amount in the case where the sales activity is performed for the customer searched for using the search condition to sell the product is higher by 10% or more than an average sales amount in the case where the sales activity is performed for the customer other than the customer searched for using the search condition to sell the product. In stage “2” of the setting pattern of “salesperson ID”, the shifting condition to the next stage is that the average sales amount in the case where the sales activity is performed for the customer searched for using the search condition to sell the product is higher by 5% or more than the average sales amount in the case where the sales activity is performed for the customer other than the customer searched for using the search condition to sell the product.

In stages “1” and “2” of the setting pattern of “random” and stages “1” and “2” of the setting pattern of “salesperson ID”, the shifting condition to the previous stage is that the sales amount in the case where the search condition is used is lower than the sales amount in the case where the search condition is not used. Specifically, the shifting condition to the previous stage is that the average sales amount in the case where the sales activity is performed for the customer searched for using the search condition to sell the product is lower than the average sales amount in the case where the sales activity is performed for the customer other than the customer searched for using the search condition to sell the product.

In this manner, in the exemplary embodiment, the setting stage is shifted based on the result of the sales activity performed by the salesperson to the customer searched for using the search condition. More specifically, in a case where an outcome of the sales activity for the customer searched for using the search condition is better than an outcome of the sales activity for the customer other than the customer searched for using the search condition, the setting stage is shifted to the next stage. In a case where the outcome of the sales activity for the customer searched for using the search condition is worse than the outcome of the sales activity for the customer other than the customer searched for using the search condition, the setting stage is shifted to the previous stage.

The shifting condition to the next stage is an example of a first condition set based on the result of the sales activity. In a case where the shifting condition to the next stage is satisfied, the setting stage of the search condition shifts to the stage where a larger number of salespersons are set in the use range. The shifting condition to the previous stage is an example of a second condition set based on the result of the sales activity. In a case where the shifting condition to the previous stage is satisfied, the setting stage of the search condition shifts to the stage where a smaller number of salespersons are set.

The “shifting condition to next stage” and the “shifting condition to previous stage” applied to each stage in each setting pattern are not limited to the examples described above. That is, any “shifting condition to next stage” described above may be applied to each stage in each setting pattern. Any “shifting condition to previous stage” may be applied to each stage in each setting pattern.

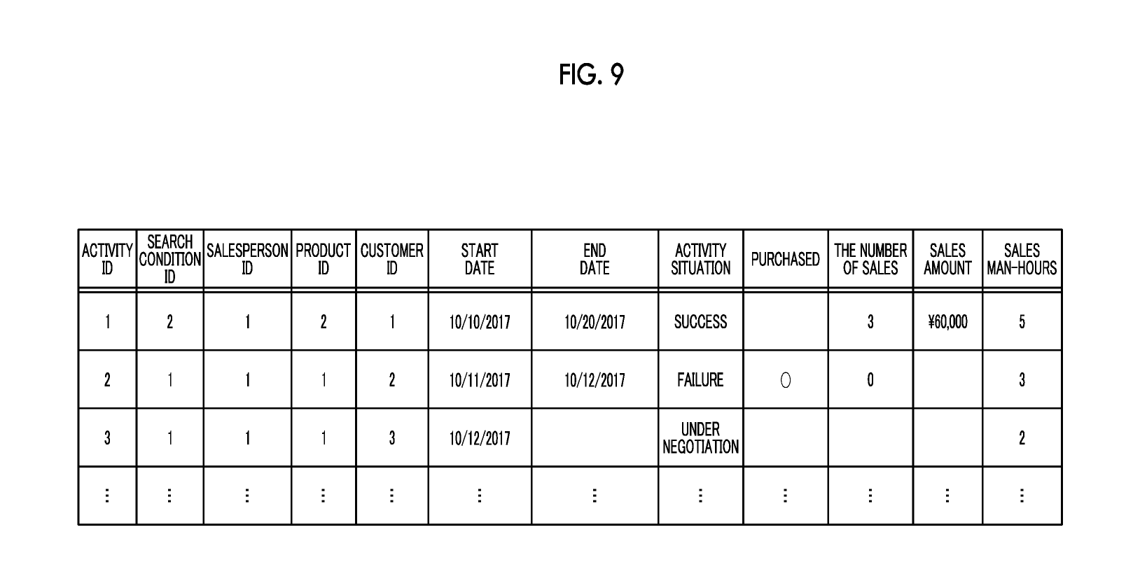

FIG. 9 is a diagram showing a configuration example of a sales activity management table. The sales activity management table is held in the sales activity information DB 14.

In the sales activity management table shown in FIG. 9, “activity ID” indicates the identification number for identifying the sales activity performed by the salesperson, and “search condition ID” indicates the identification number of the search condition used for searching for the customer relating to the sales activity. In the sales activity management table, “salesperson ID” indicates the identification number of the salesperson who performs the sales activity, and “product ID” indicates the product ID of the product that the salesperson intends to sell. “Customer ID” indicates the identification number for identifying the customer as the sales destination of the product, and “start date” and “end date” respectively indicate a date on which the sales activity is started and a date on which the sales activity is ended.

In the sales activity management table, “activity situation” indicates a situation of the sales activity, and “purchased” indicates that the customer already purchases the product before the sales activity by the symbol “O”. Furthermore, “the number of sales” indicates the number of products sold as the result of the sales activity, “sales amount” indicates the sales amount in a case where the product is sold to the customer, and “sales man-hours” indicates the time spent on the sales activity.

The sales activity management table also indicates the situation of the sales activity for the customer other than the customer searched for using the search condition (not shown).

The shifting section 18 refers to the contents of the sales activity management table to determine whether the conditions (refer to FIG. 7) relating to the contract success rate indicated as “shifting condition to next stage” and “shifting condition to previous stage” of the setting patterns of “affiliation” and “sales experience” in the setting pattern table are satisfied.

Specifically, “contract success rate in the case where search condition is used” indicated in the shifting condition (refer to FIG. 7) is a ratio of a customer with “successful contract” that is indicated in “activity situation” among customers with “end date” that is indicated after the sales activity using a target search condition in FIG. 9 is performed. The contract success rate in the case where the search condition is “not used” (refer to FIG. 7) is a ratio of the customer with “successful contract” that is indicated in “activity situation” among customers with “end date” that is indicated excluding the customers for which the sales activity using the target search condition in FIG. 9 is performed. It is determined whether “shifting condition to next stage” or “shifting condition to previous stage” is satisfied based on a comparison between the former and the latter.

The shifting section 18 refers to the contents of the sales activity management table to determine whether the conditions (refer to FIG. 8) relating to the sales man-hours indicated as “shifting condition to next stage” and “shifting condition to previous stage” of the setting pattern of “sales performance” in the setting pattern table are satisfied.

Specifically, “sales man-hours required for the successful contract using search condition” (refer to FIG. 8) indicated in the shifting condition is a value obtained by dividing a total sum of “sales man-hours” required for the customer with “successful contract” that is indicated in “activity situation” of the sales activity performed by using the search condition associated with a target product in FIG. 9 by the number of customers with “successful contract” that is indicated. The sales man-hours in the case where the search condition is “not used” (refer to FIG. 8) is a value obtained by dividing a total sum of “sales man-hours” required for the customer with “successful contract” that is indicated in “activity situation” of the sales activity performed without using the search condition associated with the product regarding the target product in FIG. 9 by the number of customers with “successful contract” that is indicated. It is determined whether “shifting condition to next stage” is satisfied based on the comparison between the former and the latter.

The shifting section 18 refers to the contents of the sales activity management table to determine whether the conditions (refer to FIG. 8) relating to the sales amount indicated as “shifting condition to next stage” and “shifting condition to previous stage” of the setting patterns of “random” and “salesperson ID” in the setting pattern table are satisfied.

Specifically, “sales amount in the case where search condition is used” (refer to FIG. 8) indicated in the shifting condition is a value obtained by dividing a total sum of “sales amount” of the customer with “successful contract” that is indicated in “activity situation” of the sales activity performed by using the search condition associated with the target product in FIG. 9 by the number of customers with “successful contract” that is indicated. The sales amount in the case where the search condition is “not used” (refer to FIG. 8) is a value obtained by dividing a total sum of “sales amount” of the customer with “successful contract” that is indicated in “activity situation” of the sales activity performed without using the search condition associated with the product regarding the target product in FIG. 9 by the number of customers with “successful contract” that is indicated. It is determined whether “shifting condition to next stage” is satisfied based on the comparison between the former and the latter.

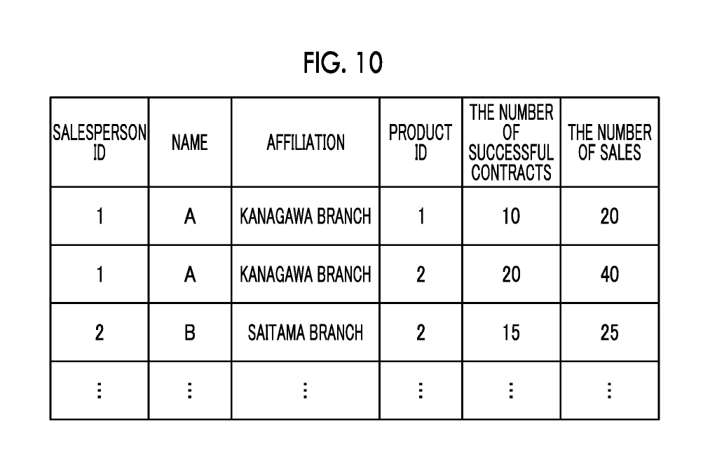

FIG. 10 is a diagram showing a configuration example of a salesperson management table. The salesperson management table is held in the salesperson information DB 13.

In the salesperson management table shown in FIG. 10, “salesperson ID” indicates the identification number of the salesperson, and “name” indicates the name of the salesperson. In the salesperson management table, “affiliation” indicates the affiliation of the salesperson, and “product ID” indicates the product ID of the product relating to the sales activity performed by the salesperson. “The number of successful contracts” indicates the number of successful contracts of the product, and “the number of sales” indicates the number of sales of the product.

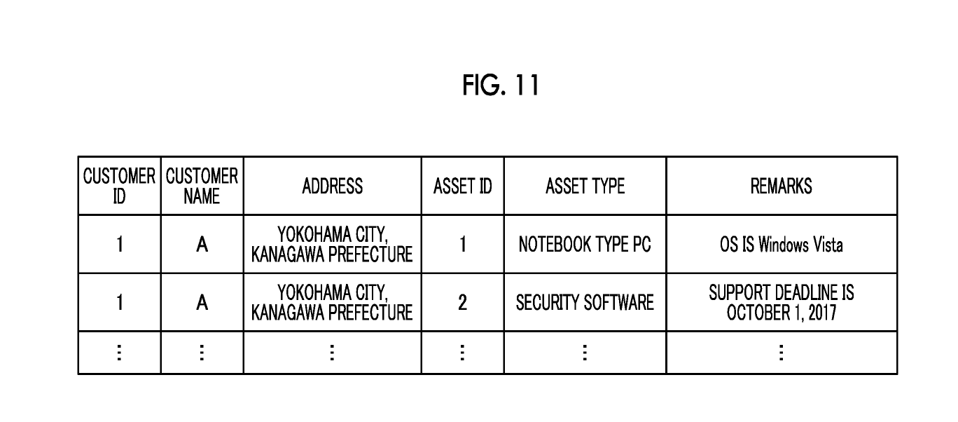

FIG. 11 is a diagram showing a configuration example of a customer management table. The customer management table is held in the customer information DB 15.

In the customer management table shown in FIG. 11, “customer ID” indicates the identification number of the customer, and “customer name” indicates the name of the customer. In the customer management table, “address” indicates the location of the customer, and “asset ID” indicates the identification number for identifying the facility owned by the customer. “Asset type” indicates the type of the facility, and “remarks” indicates additional notes relating to the facility.

The information indicated in each item in the various data tables shown in FIGS. 5 to 11 is merely an example.

Use Determination Processing

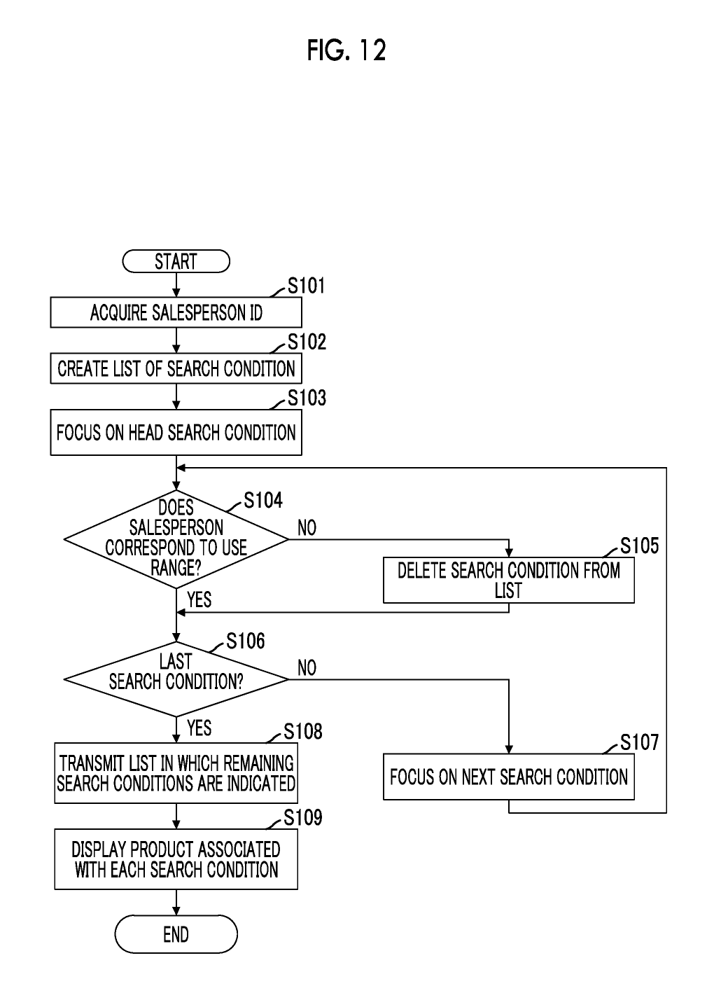

FIG. 12 is a flowchart showing a flow of use determination processing by the information processing system 100.

First, in a case where the salesperson inputs the salesperson ID to the client terminal 20 to log in, the transmitting and receiving section 16 of the management server 10 acquires the salesperson ID from the transmitting and receiving section 21 of the client terminal 20 (step S101). Next, the determination section 17 creates a list (not shown) in which each held search condition and the search condition ID are associated with each other with reference to the search condition management table (refer to FIG. 6) held in the search condition information DB 12 (step S102). The determination section 17 focuses on the search condition associated with the head search condition ID among the search conditions indicated in the list (step S103).

The determination section 17 determines whether the log-in salesperson corresponds to the use range of the search condition (step S104). Specifically, the determination section 17 determines whether the salesperson ID of the log-in salesperson is included in the use range in the setting stage of the search condition with reference to the salesperson ID and the setting pattern table (refer to FIGS. 7 and 8) acquired in step S101.

In a case where it is determined that the salesperson does not correspond to the use range of the search condition (NO in step S104), the determination section 17 deletes the search condition from the list (step S105).

In a case where it is determined that the salesperson corresponds to the use range of the search condition (YES in step S104) and step S105 ends, the determination section 17 determines whether the focused search condition among the search conditions indicated in the list is the last search condition (step S106). Specifically, the determination section 17 determines whether the focused search condition is the last search condition depending on whether the search condition ID of the focused search condition is at the last.

In a case where the focused search condition is not the last search condition (NO in step S106), the determination section 17 focuses on the search condition associated with the next search condition ID (step S107). Then, the determination section 17 executes step S104 and subsequent pieces of processing.

In a case where the focused search condition is the last search condition (YES in step S106), the transmitting and receiving section 16 transmits the list in which the remaining search conditions usable by the salesperson are indicated to the client terminal 20 (step S108). The display section 23 of the client terminal 20 displays the product associated with each search condition remained in the list with reference to the product information management table (refer to FIG. 5) and the search condition management table (refer to FIG. 6) (step S109).

Product Displayed on Client Terminal

Next, an example that the product displayed on the display section 23 is different depending on the salesperson who logs in the client terminal 20 will be described. In the example, it is assumed that the search conditions held in the search condition management table (refer to FIG. 6) are only a search condition “PC with OS that is Windows Vista is used” and a search condition “support period of security software is ended”.

First, the use determination processing performed in the case where the salesperson “A” (refer to FIG. 10) logs in the client terminal 20 will be described according to the flowchart of FIG. 12.

In the case where the salesperson “A” logs in the client terminal 20, the transmitting and receiving section 16 of the management server 10 acquires the salesperson ID “1” (refer to FIG. 10) from the transmitting and receiving section 21 of the client terminal 20 (step S101).

Next, the determination section 17 creates the list having two search conditions held in the search condition management table (refer to FIG. 6) (step S102) and focuses on the head search condition “PC with OS that is Windows Vista is used” (hereinafter, simply referred to as head search condition) (step S103).

The stage “1” in the setting pattern of “affiliation” is applied to the head search condition (refer to FIGS. 6 and 7), and the use range is correlated with the salesperson belonging to the Kanagawa branch (refer to FIG. 7). Since the salesperson “A” belongs to the Kanagawa branch (refer to FIG. 10), the determination section 17 determines whether the salesperson “A” corresponds to the use range of the head search condition (YES in step S104).

Since the head search condition is not the last search condition (NO in step S106), next, the determination section 17 focuses on the last search condition “support period of security software is ended” (hereinafter, simply referred to as last search condition) (step S107).

The stage “2” in the setting pattern of “affiliation” is applied to the last search condition (refer to FIGS. 6 and 7), and the use range is correlated with the salespersons belonging to the branches within the Kanto region (refer to FIG. 7). Since the salesperson “A” belongs to the Kanagawa branch as described above, the determination section 17 determines whether the salesperson “A” corresponds to the use range of the last search condition (YES in step S104). Since the focused search condition is not the last search condition (YES in step S106), the transmitting and receiving section 16 transmits the list having two remaining search conditions to the client terminal 20 (step S108). The display section 23 of the client terminal 20 displays a product “notebook type PC” associated with the first search condition and a product “security software” associated with the last search condition (refer to FIGS. 5 and 6) (step S109).

Next, the use determination processing performed in the case where the salesperson “B” (refer to FIG. 10) logs in the client terminal 20 will be described according to the flowchart of FIG. 12.

In the case where the salesperson “B” logs in the client terminal 20, the transmitting and receiving section 16 of the management server 10 acquires the salesperson ID “2” (refer to FIG. 10) (step S101).

Next, the determination section 17 creates the list having two search conditions held in the search condition management table (refer to FIG. 6) (step S102) and focuses on the head search condition (step S103).

The use range of the head search condition is correlated with the salesperson belonging to the Kanagawa branch (refer to FIG. 7), but the salesperson “B” belongs to a Saitama branch (refer to FIG. 10). Therefore, the determination section 17 determines that the salesperson “B” does not correspond to the use range of the head search condition (NO in step S104) and deletes the head search condition from the list (step S105).

Since the head search condition is not the last search condition (NO in step S106), next, the determination section 17 focuses on the last search condition (step S107).

The use range of the last search condition is correlated with the salespersons belonging to the branches within the Kanto region (refer to FIG. 7). Since the salesperson “B” belongs to the Saitama branch as described above, the determination section 17 determines whether the salesperson “B” corresponds to the use range of the last search condition (YES in step S104).

Since the focused search condition is not the last search condition (YES in step S106), the transmitting and receiving section 16 transmits the list in which only the last search condition is left as the search condition to the client terminal (step S108). The display section 23 displays only the product “security software” associated with the last search condition (refer to FIGS. 5 and 6) (step S109).

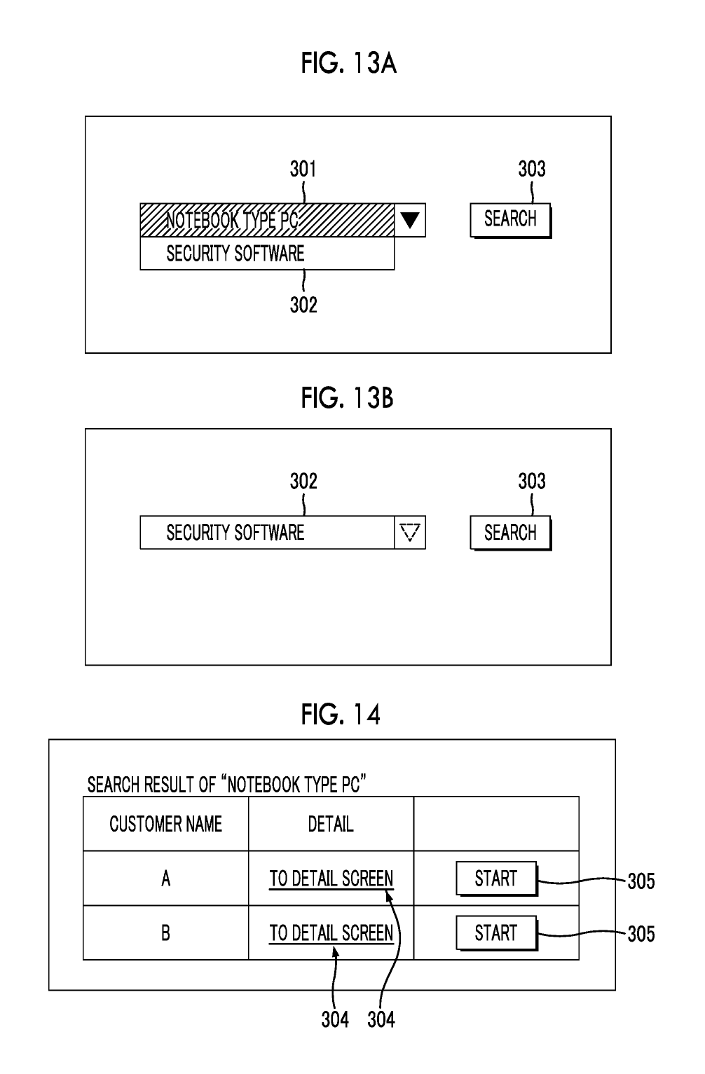

FIG. 13A is a diagram showing the products displayed on the display section 23 in the case where the salesperson “A” logs in to the client terminal 20. FIG. 13B is a diagram showing the product displayed on the display section 23 in the case where the salesperson “B” logs in to the client terminal 20.

As shown in FIG. 13A, a product button 301 of “notebook type PC” and a product button 302 of “security software” are displayed on the display section 23.

As shown in FIG. 13B, the product button 302 of “security software” is shown on the display section 23. On the other hand, the product button 301 of “notebook type PC” displayed in the case where the salesperson “A” logs in is not displayed.

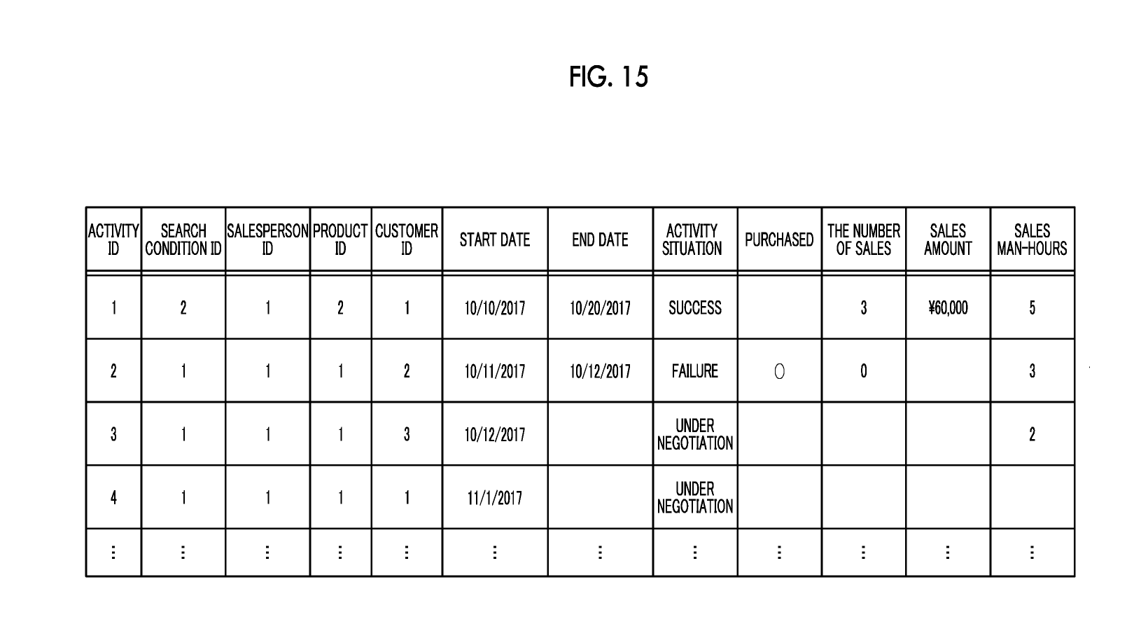

FIG. 14 is a diagram showing a search result in the case where the search of the customer is performed. FIG. 15 is a diagram showing the sales activity management table to which a situation of a new sales activity is added.

In a case where the salesperson “A” selects the product button 301 of “notebook type PC” shown in FIG. 13A and selects a search button 303, the search request for the customer is accepted and a customer corresponding to the search condition associated with the product “notebook type PC” is displayed as shown in FIG. 14. Specifically, the customer “A” and the customer “B” are displayed as the customers corresponding to the search condition.

A detail button 304 is displayed for each customer. In a case where the salesperson selects the detail button 304, the attribute of the facility of the customer such as the number of facilities owned by the customer and the type of each facility is displayed.

A start button 305 of the sales activity is displayed for each customer. In a case where the salesperson “A” selects the start button 305 associated with the customer “A”, the situation of the sales activity of the salesperson “A” to the customer “A” is newly added to the sales activity management table as shown in FIG. 15. The sales activity management table respectively displays the activity ID “4” as the identification number of the sales activity, the search condition ID “1” representing the search condition used for the search of the customer “A”, the salesperson ID “1” for identifying the salesperson “A”, the product ID “1” for identifying “notebook type PC” to be sold in the sales activity, and the customer ID “1” for identifying the customer “A”. A date on which the salesperson “A” pushes the start button 305 as the start date of the sales activity and “under negotiation” representing under the sales activity as the situation of the sales activity are respectively displayed. In a case where the situation of the sales activity is updated or the sales activity ends, the salesperson “A” can update the sales activity management table by inputting the result of the sales activity such as “activity situation”, “purchased”, “the number of sales”, “sales amount”, and “sales man-hours”.

The “end date” may be input by the salesperson or may be indicated as the date on which “activity situation” is input. The sales activity management table indicates “name”, “product name”, and “customer name” of the salesperson associated with “activity ID”.

The salesperson “B” can also use the search of the customer using the search condition for the product “security software” shown in FIG. 13B. However, in the case where the salesperson “B” logs in the client terminal 20, the product “notebook type PC” is not displayed on the display section 23 and the salesperson “B” cannot perform the search of the customer as the sales destination of the product “notebook type PC”.

In the exemplary embodiment, in the case where the salesperson “B” does not correspond to a range in which the search condition is capable of being used, the product “notebook type PC” relating to this search condition is not displayed to make it easier for the salesperson “B” to recognize a searchable product, but a display mode of the display section 23 is not limited to the examples described above. For example, in a case where the search request for the customer using the search condition associated with the product “notebook type PC” by the salesperson “B” is not accepted by the search section 19, this product “notebook type PC” may be displayed.

In this manner, in the exemplary embodiment, the search of the customer using the search condition is performed by the search section 19 in response to the search request of the salesperson corresponding to the range in which the search condition is capable of being used in the setting stage of the search condition. In other words, when the range of the salesperson that is usable by the salesperson authenticated based on authentication information acquired by the acquisition section 22 corresponds to the range in which the search condition set in stages is usable, the search request for the customer using the search condition is accepted by the input accepting section 24. Furthermore, in other words, when the salesperson authenticated by the acquisition section 22 corresponds to the range in which the search condition is capable of being used, the search using the search condition is performed by the search section 19 in response to the search request of the salesperson.

On the other hand, the search request from the salesperson not corresponding to the range in which the search condition is capable of being used in the setting stage of the search condition cannot be accepted. That is, the salesperson not corresponding to the range in which the search condition is capable of being used in the setting stage of the search condition cannot use the search of the customer using the search condition.

Here, in a case where the search of the customer using the search condition is performed without limiting the salesperson capable of using the search condition, there is a risk that the scale of the disadvantage due to the sales activity increases in a case where a customer inappropriate for the sales destination of the product is searched for.

Specifically, the search condition is used for searching for the customer appropriate for the sales destination of the product. However, in a case where the accuracy of the search condition is low, the customer inappropriate for the sales destination of the product may be searched for and it is difficult to sell the product even though the sales activity is performed for the customer.

In such case, in the case where the search using the search condition is performed without limiting the salesperson capable of using the search condition and the sales activity is performed for the searched customer, there is a risk that the efficiency in the sales activity is reduced or the scale of the disadvantage such as waste of an opportunity for the sales activity increases.

On the contrary, in the exemplary embodiment, the specific salesperson is set as the salesperson capable of using the search condition, and only the set salesperson can use the search of the customer using the search condition.

In the case, the salesperson who performs the sales activity to the searched customer is limited. As a result, even in the case where the customer inappropriate for the sales destination is searched for in the case of using the search condition, the scale of the disadvantage due to the sales activity for the customer decreases.

Shifting Processing

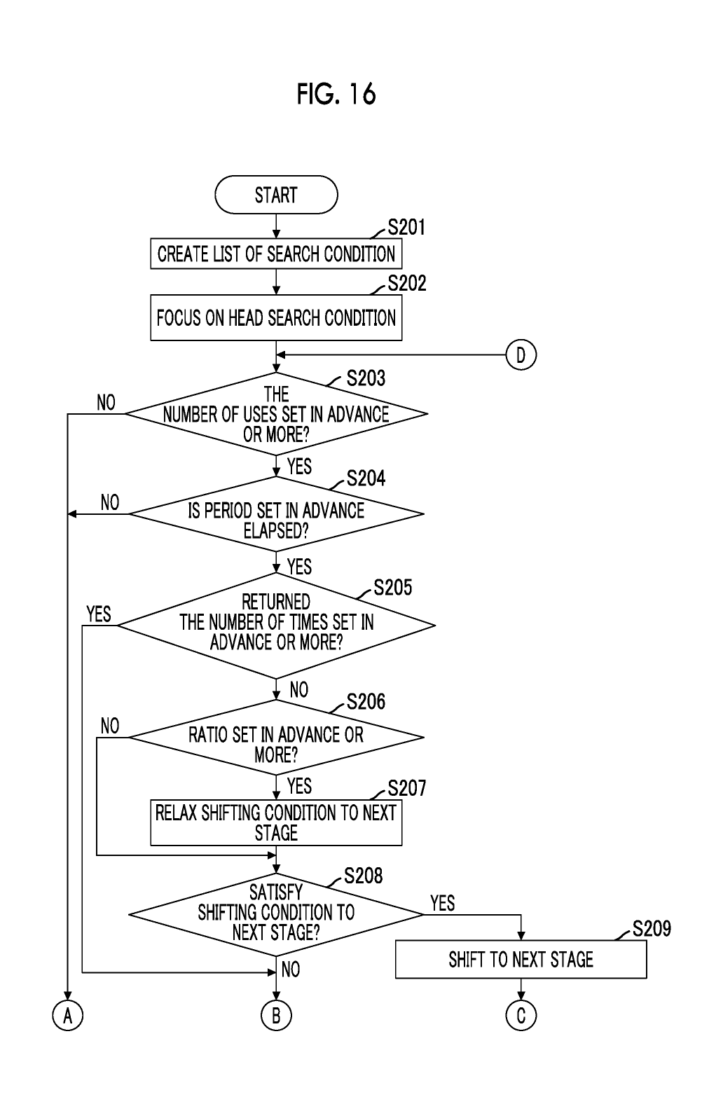

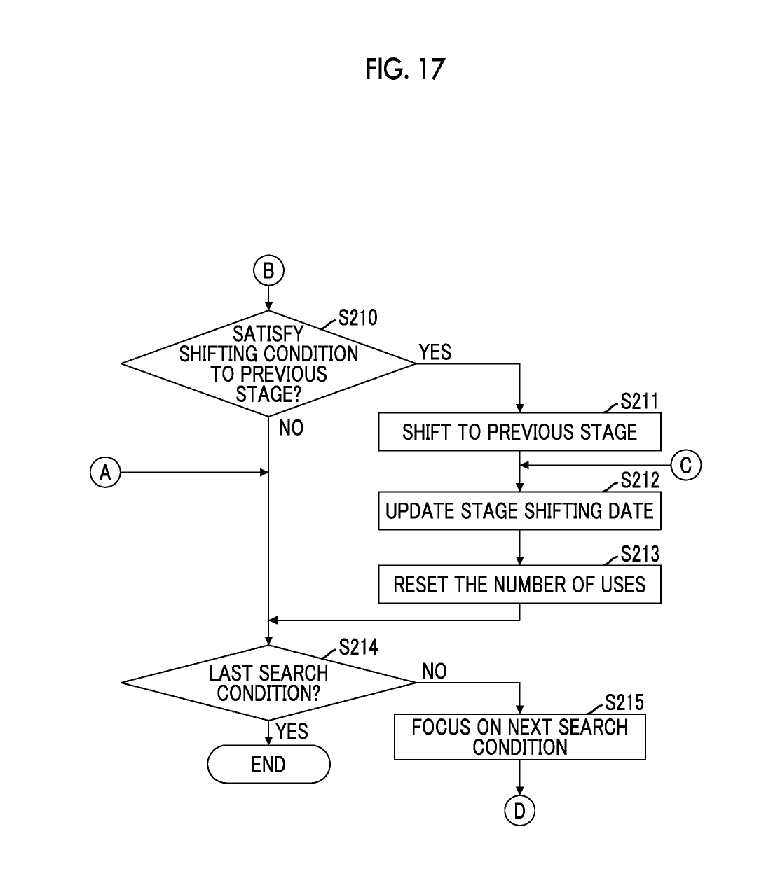

FIGS. 16 and 17 are flowcharts showing a flow of the shifting processing by the information processing system 100. The shifting processing is performed periodically, for example, once a day.

As shown in FIG. 16, first, the shifting section 18 of the management server 10 creates a list (not shown) in which each search condition and the search condition ID are associated with each other with reference to the search condition management table (refer to FIG. 6) (step S201). The shifting section 18 focuses on the search condition associated with the head search condition ID among the search conditions indicated in the list (step S202).

Next, the shifting section 18 determines whether the search of the customer using the search condition is performed the number of uses set in advance (for example, 100 times) or more (step S203). The number of uses set in advance is a threshold value for determining that the number of uses of the search using the search condition is small after the last stage shifting (after stage is set in a case where the stage is not shifted). In a case where the search using the search condition is not performed the number of uses set in advance, the shifting section 18 determines that the number of uses of the search condition after the stage is newly set is small. For example, in a case where the search condition ID (refer to FIG. 6) is the search condition “PC with OS that is Windows Vista is used” of “1”, since the number of uses of the search condition after the stage is newly set is 200 times, the shifting section 18 determines that the search of the customer using the search condition is performed the number of uses set in advance or more.

The number of searches using the search condition may be the number of times the search button 303 (refer to FIG. 13A) is selected regarding the search condition or the number of times the sales activity is performed for the customer searched for using the search condition. In a case where the number of times the sales activity is performed for the customer searched for using the search condition is set as the number of searches using the search condition, the number of searches corresponds to the number of “activity IDs” associated with “search condition ID” of the target search condition in the sales activity management table (refer to FIG. 9).

In a case where the search using the search condition is the number of uses set in advance or more (YES in step S203), the shifting section 18 determines whether a period set in advance (for example, two months) elapses after the stage is newly set (step S204). The period set in advance is a threshold value for determining that the period elapsed after the stage is newly set is short. In a case where the period elapsed after the stage is newly set does not elapse the period set in advance, the shifting section 18 determines that the period elapsed after the stage is newly set is short.

In a case where the period set in advance elapses after the stage is newly set (YES in step S204), the processing proceeds to the next step. That is, the shifting section 18 determines whether the shifting (returning) is performed the number of times set in advance (for example, three times) or more from the stage where a larger number of salespersons are set to the stage where a smaller number of salespersons are set (step S205). The number of times set in advance is a threshold value for determining that the number of times the setting stage is returned is large. In a case where the shifting is performed the number of times set in advance or more from the stage where a larger number of salespersons are set to the stage where a smaller number of salespersons are set, the shifting section 18 determines that the number of times the setting stage is returned is large. For example, in a case where the symbol “O” is indicated in “shifting history” of the search condition management table (refer to FIG. 6), the shifting section 18 determines that the shifting is performed the number of times set in advance or more from the stage where a larger number of salespersons are set to the stage where a smaller number of salespersons are set.

In a case where the shifting is not performed the number of times set in advance or more from the stage where a larger number of salespersons are set to the stage where a smaller number of salespersons are set (NO in step S205), the processing proceeds to the next step. That is, the shifting section 18 determines whether a ratio of the customer who already purchases the product before the sales activity among the customers for which the sales activity of the product associated with the search condition is performed is equal to or larger than a ratio set in advance (step S206). The ratio set in advance is a threshold value for determining that the ratio of the customer who already purchases the product before the sales activity is large. In a case where the ratio of the customer who already purchases the product before the sales activity among the customers for which the sales activity of the product is performed is equal to or larger than the ratio set in advance, the shifting section 18 determines that the ratio of the customer who already purchases the product is large. The ratio of the customer who already purchases the product before the sales activity is calculated from a ratio of the customer with “O” that is indicated in “purchased” among the customers associated with the target product in the sales activity management table (refer to FIG. 9).

The ratio of the customer who already purchases the product before the sales activity among the customers for which the sales activity of the product is performed is equal to or larger than the purchased ratio set in advance (YES in step S206), the processing proceeds to the next step. That is, the shifting section 18 relaxes the shifting condition for shifting the setting stage of the search condition to the next stage (step S207). The relaxing of the shifting condition will be described below.

After the shifting condition is relaxed or in a case where it is determined as NO in step S206, the shifting section 18 determines whether the shifting condition to the next stage is satisfied (step S208). Specifically, the shifting section 18 determines whether “shifting condition to next stage” associated with a current setting stage in the setting pattern applied to the search condition is satisfied with reference to the setting pattern table (refer to FIGS. 7 and 8). In a case where it is determined as YES in step S205, the shifting section 18 determines whether the shifting condition is satisfied with reference to “relaxation condition” associated with the setting pattern applied to the search condition of the setting pattern table.

In a case where the shifting condition to the next stage is satisfied (YES in step S208), the shifting section 18 shifts the setting stage of the search condition to the next stage, that is, to stage “2” in a case where the setting stage is “1” and to stage “3” in a case where the setting stage is “2” (step S209).

On the other hand, in a case where the shifting condition to the next stage is not satisfied (NO in step S208) or in a case where it is determined as NO in step S205, the processing proceeds to the next step. That is, as shown in FIG. 17, the shifting section 18 determines whether the shifting condition to the setting stage is satisfied (step S210). Specifically, the shifting section 18 determines whether “shifting condition to next stage” associated with the current setting stage in the setting pattern applied to the search condition is satisfied with reference to the setting pattern table (refer to FIGS. 7 and 8).

In a case where the shifting condition to the previous stage is satisfied (YES in step S210), the shifting section 18 shifts the setting stage of the search condition to the previous stage, that is, to stage “2” in a case where the setting stage is “3” and to stage “1” in a case where the setting stage is “2” (step S211).

In a case where step S209 in FIG. 16 ends or step S211 in FIG. 17 ends, the shifting section 18 updates the date indicated in “stage shifting date” of the search condition management table (refer to FIG. 6) to a date on which the setting stage is newly shifted (step S212). Furthermore, the shifting section 18 resets the number of times of the search condition management table to zero (step S213).

In a case where it is determined as NO in step S203, as NO in step S204 in FIG. 16, or as NO in step S210, or step S213 ends in FIG. 17, the processing proceeds to the next step. That is, as shown in FIG. 17, the shifting section 18 determines whether the focused search condition is the last search condition (step S214). Specifically, the shifting section 18 determines whether the focused search condition is the last search condition depending on whether the search condition ID of the focused search condition is at the last.

In a case where the focused search condition is not the last search condition (NO in step S214), the shifting section 18 focuses on the search condition associated with the next search condition ID (step S215). The shifting section 18 executes step S203 and subsequent pieces of processing in FIG. 16.

In a case where the focused search condition is the last search condition (YES in step S214), the shifting processing by the information processing system 100 ends.

In this manner, in the exemplary embodiment, the result of the sales activity set in advance is set as the shifting condition of shifting the setting stage of the search condition. In a case where the result of the sales activity performed by the salesperson to the customer searched for using the search condition satisfies the result set in advance, the setting stage of the search condition shifts.

In such case, the range of the salesperson capable of using the search condition is set according to the result of the sales activity performed using the search condition.

In the exemplary embodiment, in the case where the result of the sales activity performed by the salesperson to the customer searched for using the search condition satisfies the shifting condition to the next stage, the range of the salesperson capable of using the search condition is expanded. In the case where the result of the sales activity performed using the search condition satisfies the shifting condition to the previous stage, the range of the salesperson capable of using the search condition is reduced.

As described above, in the case where the accuracy of the search condition is low, since a larger number of customers inappropriate for the sales destination of the product are searched for, it is difficult to make the sale of the product successful even though the sales activity is performed for the searched customers. On the other hand, in the case where the accuracy of the search condition is high, since a larger number of customers appropriate for the sales destination of the product are searched for, it is easier to make the sale of the product successful in the case where the sales activity is performed for the searched customers.

Thus, in the exemplary embodiment, the accuracy of the search condition is determined based on the comparison between the result of the sales activity for the customer searched for using the search condition and the result of the sales activity for the customer other than the customer searched for using the search condition. In a case where it is determined that it is easier to sell the product to the searched customer and the accuracy of the search condition is high, the range of the salesperson capable of using the search condition is expanded to increase the scale of the sales activity to the searched customer. In a case where it is determined that it is difficult to sell the product to the searched customer and the accuracy of the search condition is low, the range of the salesperson capable of using the search condition is reduced to decrease the scale of the sales activity to the searched customer.

In such case, the scale of the advantage due to the sales activity increases in a case where the result of the sales activity is favorable after the use range of the search condition is expanded, and the scale of the disadvantage due to the sales activity decreases in a case where the result of the sales activity is not favorable after the use range of the search condition is reduced.

In the exemplary embodiment, in the case where the ratio of the customer who already purchases the product before the sales activity among the customers for which the sales activity of the product associated with the search condition is performed is equal to or larger than the ratio set in advance, the condition for shifting from the stage applied to the search condition to the next stage is relaxed.

In the case where the customer already purchases the product that is intended to be sold in the sales activity, it is conceivable that a competitor already performs the sale of the product to the customer. In such case, in a case where the use range of the search condition is reduced and the scale of the sales activity remains small, there is a risk that a customer who does not yet purchase the product that is intended to be sold is also taken by the competitor and the opportunity for the sales activity is lost.

Thus, in the exemplary embodiment, in the case where it is determined that the ratio of the customer who already purchases the product that is intended to be sold is large, it is easier to shift the stage applied to the search condition regarding the product to the next stage.

Accordingly, the use range of the search condition is expanded to make the scale of the sales activity easier to increase, and the loss of the opportunity for the sales activity for the customer who does not yet purchase the product that is intended to be sold is suppressed.

In the exemplary embodiment, in a case where the setting stage of the search condition shifts the number of times set in advance from the stage where a larger number of salespersons are set to the stage where a smaller number of salespersons are set, the setting stage does not shift to the next stage even though the shifting condition to the next stage is satisfied.

In the exemplary embodiment, in the case where it is determined that the accuracy of the search condition is high, the use range of the search condition is expanded to increase the scale of the sales activity. However, in the case where the result of the sales activity is not favorable after the scale is increased, the disadvantage occurs. In such case, in the state where the setting stage shifts to the next stage, in a case where the disadvantage due to the sales activity occurs every time the sales activity using the search condition is performed, the scale of the disadvantage is likely to be increased.

Thus, as in the exemplary embodiment, in the case where the number of times that the setting stage shifts to the next stage but returns to the previous stage is large, the setting stage is not shifted to the next stage. Consequently, in the state where the setting stage shifts to the next stage, the occurrence of the disadvantage due to the sales activity every time the sales activity is performed is suppressed.

In the exemplary embodiment, in the case where the period set in advance does not elapse after the stage of the use range is newly set as the search condition, the setting stage does not shift to the next stage even though the shifting condition to the next stage is satisfied.

For example, the outcome of the sales activity may improve due to a short-term factor different from a degree of the accuracy of the search condition, such as a price reduction of the product for a limited period. In such case, in a case where there is no short-term factor, the outcome of the sales activity may become difficult to improve. At this time, in a case where the use range of the search condition is expanded based on the improvement of the outcome of the sales activity due to the short-term factor, the scale of the disadvantage due to the sales activity may increase.

On the contrary, as in the exemplary embodiment, in a case where the setting stage does not shift to the next stage within a short time after the stage of the use range is newly set as the search condition, the expansion of the use range of the search condition based on the improvement of the outcome of the sales activity due to the short-term factor is suppressed. Accordingly, the occurrence of the disadvantage due to the increase in the scale of the sales activity is suppressed regardless of the absence of the short-term factor that improves the outcome of the sales activity.

In the exemplary embodiment, in the case where the search using the search condition is not used the number of times set in advance after the stage of the use range is newly set as the search condition, the setting stage does not shift to the next stage even though the shifting condition to the next stage is satisfied.

In such case, the expansion of the use range of the search condition due to the presence of the factor that improves the outcome of the sales activity is suppressed only before the search using the search condition is used the number of times set in advance after the stage of the use range is newly set as the search condition. Accordingly, the occurrence of the disadvantage due to the increase in the scale of the sales activity is suppressed regardless of the absence of the factor that improves the outcome of the sales activity after the search using the search condition is used the number of times set in advance.

The exemplary embodiment of the present invention is described above, but a technical scope of the present invention is not limited to the exemplary embodiment described above. Various modifications and configuration alternatives without departing from the scope of the technical idea of the present invention are included in the present invention. For example, in the exemplary embodiment described above, the management server 10 is configured to hold and manage the product information DB 11, the search condition information DB 12, the salesperson information DB 13, the sales activity information DB 14, and the customer information DB 15. However, a management server that holds these databases may configured to be provided separately from the management server 10.

In the exemplary embodiment, it is determined whether to shift the setting stage of the search condition based on the result of the sales activity such as the contract success rate, the sales man-hours, and the sales amount. However, the sales activity as a determination material may be the sales activities performed within a certain period or may be the entire sales activity. The case where it is determined whether to shift the setting stage of the search condition based on the result of the sales activity performed within the certain period includes, for example, a case where it is determined whether to shift the setting stage of the search condition based on the result of the sales activity performed during the most recent month.

In the exemplary embodiment, the shifting condition of the setting stage in the search condition is set based on the comparison between the result of the sales activity for the customer searched for using the search condition and the result of the sales activity for the customer other than the customer searched for using the search condition, but the present invention is not limited thereto. For example, the shifting condition of the setting stage in the search condition may be set based on the result of the sales activity for the customer searched for using the search condition regardless of the result of the sales activity for the customer other than the customer searched for using the search condition.

In the exemplary embodiment, the customer corresponding to the search condition is displayed on the display section 23, but the present invention is not limited thereto. For example, the customer not corresponding to the search condition may be displayed on the display section 23.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a setting section that sets a range of a user capable of using a search condition for searching for a customer to any stage among a plurality of stages; and
a search section that performs a search using the search condition in response to a search request of the user corresponding to the range in which the search condition is capable of being used, in the stage set by the setting section.

2. The information processing apparatus according to claim 1,
wherein the search section does not accept a search request from the user not corresponding to the range in which the search condition is capable of being used in the stage set by the setting section.

3. The information processing apparatus according to claim 2, further comprising:
a display section that displays a product as a search key and a result of the search by the search section,
wherein the search section searches for the customer based on the search condition relating to the product in response to the search request from the user with the product displayed on the display section as the search key; and
wherein in a case where the user does not correspond to the range in which the search condition is capable of being used, the display section does not display the product relating to the search condition.

4. The information processing apparatus according to claim 1,
wherein the setting section is capable of shifting the set stage based on a result of a sales activity performed by a salesperson to the customer searched for using the search condition by the search section.

5. The information processing apparatus according to claim 4,
wherein the setting section shifts the set stage to a stage where a larger number of users are set in a case where a first condition set based on the result of the sales activity is satisfied, and shifts the stage to a stage where a smaller number of users are set in a case where a second condition set based on the result of the sales activity is satisfied.

6. The information processing apparatus according to claim 5,
wherein the first condition is that a contract success rate in a case where the sales activity is performed for the customer searched for using the search condition is higher than a contract success rate in a case where the sales activity is performed for a customer other than the customer searched for using the search condition; and
wherein the second condition is that the contract success rate in the case where the sales activity is performed for the customer searched for using the search condition is less than the contract success rate in the case where the sales activity is performed for the customer other than the customer searched for using the search condition.

7. The information processing apparatus according to claim 6,
wherein the first condition is that the contract success rate of the result of the sales activity performed for the customer searched for using the search condition improves by a first ratio set in advance or more as compared with the contract success rate of the result of the sales activity performed for the customer other than the customer searched for using the search condition; and
wherein in a case where a ratio of a customer who already purchases the product before the sales activity among the customers for which the sales activity is performed is equal to or larger than a ratio set in advance, the setting section applies as the first condition that the contract success rate improves by a second ratio or more, the second ratio being smaller than the first ratio.

8. The information processing apparatus according to claim 5,
wherein in a case where the stage where the range of the user is set shifts the number of times set in advance from the stage where a larger number of users are set to the stage where a smaller number of users are set, the setting section does not shift the set stage to the stage where a larger number of users are set even though the first condition is satisfied.

9. The information processing apparatus according to claim 5,
wherein in a case where a period set in advance does not elapse after the stage is set, the setting section does not perform the shift of the stage even though the first condition is satisfied.

10. The information processing apparatus according to claim 5,
wherein in a case where the search using the search condition is not used the number of times set in advance after the stage is set, the setting section does not perform the shift of the stage even though the first condition is satisfied.

11. The information processing apparatus according to claim 1,
wherein a plurality of types of setting patterns are provided as a pattern for setting the range of the user capable of using the search condition according to the stage; and
wherein the setting section applies any of the setting patterns for each search condition.

12. The information processing apparatus according to claim 11,
wherein the setting section sets the range of the user capable of using the search condition in stages based on a history of the sales activity performed by the user in one setting pattern.

13. An information processing system comprising:
an acquisition unit that acquires authentication information of a user;
an accepting unit that accepts a search request for a customer using a search condition when a range of a user that is usable by the user authenticated based on the authentication information acquired by the acquisition unit corresponds to a range in which the search condition set in stages is usable; and
a display unit that displays the customer searched for based on the search request accepted by the accepting unit.

14. An information processing system comprising:
a setting unit that sets a range of a user capable of using a search condition for searching for a customer in stages;
an authentication unit that performs authentication of the user;
a search unit that performs a search using the search condition in response to a search request from the user when the user authenticated by the authentication unit corresponds to the range in which the search condition is capable of being used; and
a display unit that displays a customer searched for by the search unit.

15. A non-transitory computer readable medium storing a program causing a computer to realize a function, the function comprising:
setting a range of a user capable of using a search condition for searching for a customer to any stage among a plurality of stages; and
performing a search using the search condition in response to a search request of the user corresponding to the range in which the search condition is capable of being used, in the set stage.
